(19) United States
(12) Patent Application Publication
(10) Pub. No.: US 2025/0303512 A1
(43) Pub. Date: Oct. 2, 2025

(54) SURFACE TREATMENT TOOL

(71) Applicant: Nanjing Chervon Industry Co., Ltd., Nanjing (CN)

(72) Inventors: Fengyu Zhang, Nanjing (CN); Sam Billington, Nanjing (CN); Chris Anssems, Nanjing (CN)

(21) Appl. No.: 19/240,784

(22) Filed: Jun. 17, 2025

Related U.S. Application Data
(63) Continuation of application No. PCT/CN2024/118686, filed on Sep. 13, 2024.

(30) Foreign Application Priority Data
Sep. 22, 2023 (CN) 202311234435.8

(51) Int. Cl. B24B 23/02

(52) U.S. Cl. CPC B24B 23/02

(57) ABSTRACT

A surface treatment tool includes a housing, a drive assembly, a transmission system, and a working accessory. The drive assembly is disposed in the housing and includes an electric motor. The transmission system includes an input shaft and an output shaft. The working accessory is connected to the output shaft. A first plane P1 is defined, the point of intersection between the first plane P1 and the input axis is a first point of intersection C1, the point of intersection between the first plane P1 and the output axis is a second point of intersection C2, the line connecting C1 and C2 is a transmission centerline, the included angle between the projection line of the motor axis onto the first plane P1 and the transmission centerline is a first included angle α that is greater than or equal to 90 degrees and less than or equal to 170 degrees.

### RELATED APPLICATION INFORMATION

This application is a continuation of International Application Number PCT/CN2024/118686, filed on Sep. 13, 2024, through which this application also claims the benefit under 35 U.S.C. § 119(a) of Chinese Patent Application No. CN 202311234435.8, filed on Sep. 22, 2023, which applications are incorporated herein by reference in their entireties.

### TECHNICAL FIELD

The present application relates to a power tool, for example, a surface treatment tool.

### BACKGROUND

For a surface treatment tool in the related art, an electric motor drives a wire drawing wheel to rotate through a deceleration mechanism, and the wire drawing wheel rotates to polish the surface to be polished. The deceleration mechanism usually includes a primary bevel gear transmission mechanism and a secondary pulley transmission mechanism, and the wire drawing wheel is disposed on the output shaft of the pulley transmission mechanism. In the wire drawing machine in the related art, the deceleration mechanism is disposed in front of the electric motor so that the motor axis is parallel to the centerline of the belt. That is to say, the whole machine is basically arranged in a straight line in the front and rear direction, resulting in a relatively small space below the whole machine, which is not convenient for arranging other components.

This part provides background information related to the present application, and the background information is not necessarily the existing art.

### SUMMARY

The present application adopts the technical solutions below.

A surface treatment tool includes: a housing; a drive assembly disposed in the housing and including an electric motor, where a motor shaft of the electric motor is rotatable about a motor axis; a transmission system driven by the electric motor to rotate and including an input shaft and an output shaft, where the input shaft is rotatable about an input axis, the output shaft is rotatable about an output axis, the input shaft is connected to the motor shaft, and the output shaft is drivingly connected to the input shaft; and a working accessory connected to the output shaft and being rotatable about the output axis. A first plane P1 is defined, where the first plane P1 is basically perpendicular to the left and right direction of the surface treatment tool, the point of intersection between the first plane P1 and the input axis is a first point of intersection C1, the point of intersection between the first plane P1 and the output axis is a second point of intersection C2, the line connecting the first point of intersection C1 and the second point of intersection C2 is a transmission centerline, the included angle between the projection line of the motor axis onto the first plane P1 and the transmission centerline is a first included angle α, and the first included angle α is greater than or equal to 90 degrees and less than or equal to 170 degrees.

In some examples, the first included angle α is greater than or equal to 120 degrees and less than or equal to 160 degrees.

In some examples, along the extension direction of the input shaft, the distance between the motor axis and the transmission centerline is a first distance L, where the first distance L is greater than or equal to 4 cm and less than or equal to 10 cm.

In some examples, a dust suction port is disposed below the housing, the dust generated during the operation of the surface treatment tool is discharged into a dust collection device through the dust suction port, and the dust suction port is located between the motor axis and the transmission centerline.

In some examples, a dust suction pipe is disposed at the dust suction port, and in the vertical direction, the dust suction pipe at least partially overlaps the housing.

In some examples, the dust suction port is located below the electric motor.

In some examples, the transmission system further includes a first housing and a belt transmission mechanism disposed in the first housing, the belt transmission mechanism is drivingly connected to the input shaft and the output shaft, and the input shaft and the output shaft both penetrate the first housing.

In some examples, the belt transmission mechanism is located in front of the electric motor and biased to the left side or right side of the motor axis.

In some examples, the belt transmission mechanism includes a driving pulley, a driven pulley, and a belt wound around the driving pulley and the driven pulley, the driving pulley is disposed on the input shaft, and the driven pulley is disposed on the output shaft.

In some examples, a shaft locking structure is disposed on the first housing and is capable of locking the driven pulley.

In some examples, the transmission system further includes a second housing and a bevel gear transmission mechanism disposed in the second housing, the input shaft penetrates the second housing, and the bevel gear transmission mechanism is drivingly connected to the motor shaft and the input shaft.

In some examples, the bevel gear transmission mechanism includes a first bevel gear and a second bevel gear, the first bevel gear is disposed on the motor shaft, the second bevel gear is disposed on the input shaft, and the first bevel gear meshes with the second bevel gear.

In some examples, the transmission system further includes a connecting housing, the second housing is located between the connecting housing and the first housing, the second housing and the housing are detachably connected via a first locking member, and the first housing, the second housing, and the connecting housing are detachably connected via a second locking member.

In some examples, a battery pack is further included, where a mounting portion is formed on or connected to the housing, the battery pack is detachably disposed on the mounting portion, a second included angle β is formed between the plugging and unplugging direction of the battery pack and the motor axis, and the second included angle β is greater than or equal to 0 degrees and less than or equal to 90 degrees.

In some examples, the second included angle β is equal to 90 degrees, and the plugging and unplugging direction of the battery pack is parallel to or perpendicular to the central axis of the output shaft.

In some examples, the second included angle β is greater than or equal to 10 degrees and less than or equal to 80 degrees.

In some examples, a power cord is further included, where a connecting portion is formed on the housing, and the power cord is connected to the connecting portion.

In some examples, an auxiliary handle is disposed on the housing, the auxiliary handle has an accommodation cavity, and the accommodation cavity is configured to accommodate a wrench.

In some examples, the wrench is capable of being inserted into the accommodation cavity along the direction of a second straight line, where the second straight line is perpendicular to the motor axis.

In some examples, the wrench is magnetically connected to the auxiliary handle.

In some examples, the input axis is basically parallel to the output axis.

In some examples, at least one of the input axis and the output axis is basically perpendicular to the motor axis.

In some examples, a grip is formed on the housing, and an included angle formed by the motor axis and the extension direction of the grip is greater than 0 degrees and less than 90 degrees.

In some examples, the working accessory is connected to the output shaft via a flat key, a groove for mating with the flat key is disposed on the working accessory, and the flat key and the output shaft are attracted magnetically.

### BRIEF DESCRIPTION OF THE DRAWINGS

FIG. 1 is structural view one of a surface treatment tool according to the present application.

FIG. 2 is structural view two of a surface treatment tool according to the present application.

FIG. 3 is structural view three of a surface treatment tool according to the present application.

FIG. 4 is exploded view one of some structures of a surface treatment tool according to the present application.

FIG. 5 is exploded view two of some structures of a surface treatment tool according to the present application.

FIG. 6 is a schematic view of a shaft locking structure according to the present application.

FIG. 7 is a schematic view of some structures of a surface treatment tool according to the present application.

FIG. 8 is a schematic view of some structures of a surface treatment tool according to the present application, illustrating a first plane.

FIG. 9 is a front view of some structures of a surface treatment tool according to the present application, illustrating a first plane.

FIG. 10 is a top view of some structures of a surface treatment tool according to the present application.

FIG. 11 is a front view of some structures of a surface treatment tool according to the present application.

FIG. 12 is a top view of some structures of another surface treatment tool according to the present application.

FIG. 13 is a schematic view illustrating the axes of another surface treatment tool according to the present application.

FIG. 14 is a front view of a surface treatment tool according to the present application.

FIG. 15 is exploded view one of a surface treatment tool according to the present application.

FIG. 16 is a front view of some structures of another surface treatment tool according to the present application.

FIG. 17 is a front view of some structures of another surface treatment tool according to the present application.

FIG. 18 is exploded view two of a surface treatment tool according to the present application.

FIG. 19 is an exploded view of an output shaft and flat keys according to the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

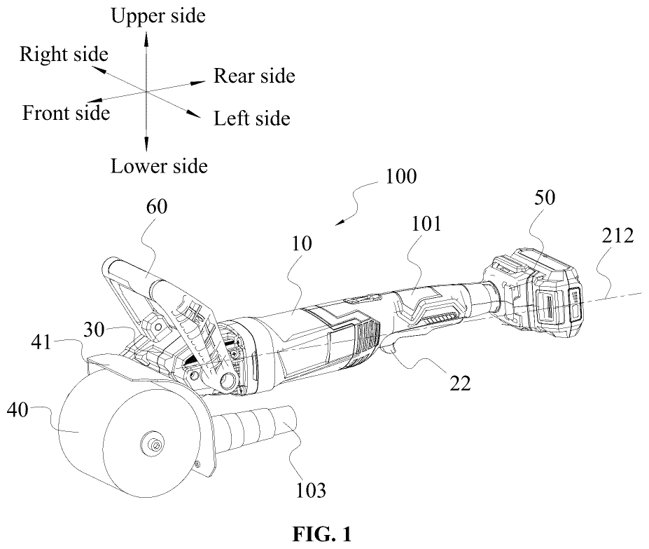

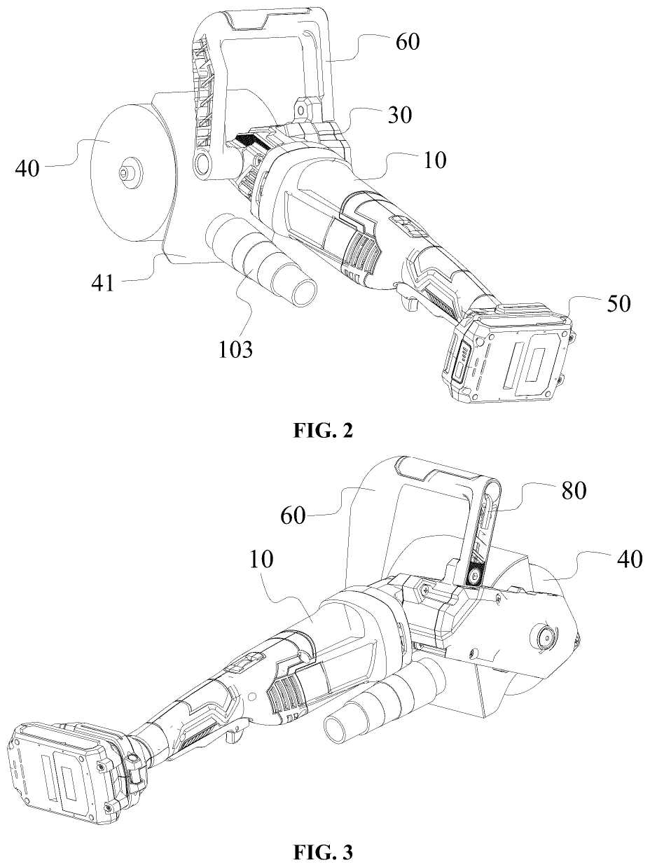

As shown in FIGS. 1 to 4, the present application provides a surface treatment tool 100, which may be a grinder, a sander, a wire drawing machine, or the like. The surface treatment tool 100 includes a housing 10, a drive assembly 20, a transmission system 30, and a working accessory 40. The drive assembly 20 is disposed in the housing 10 and includes an electric motor 21. The electric motor 21 has a motor shaft 211, and the central axis of the motor shaft 211 is a motor axis 212. The transmission system 30 is driven by the electric motor 21 to rotate and includes an input shaft 31 and an output shaft 32. The input shaft 31 is rotatable about an input axis 311, and the output shaft 32 is rotatable about an output axis 321. The input shaft 31 is connected to the motor shaft 211, the output shaft 32 is drivingly connected to the input shaft 31, the working accessory 40 is connected to the output shaft 32, and the working accessory 40 is rotatable about the output axis 321. The motor shaft 211 drives the input shaft 31 to rotate and then drives the output shaft 32 to rotate, thereby driving the working accessory 40 to rotate.

The surface treatment tool 100 further includes an energy source for supplying energy to the surface treatment tool 100. The energy source may be alternating current power or direct current power such as a battery pack 50 or another portable mobile power supply. In some examples, the surface treatment tool 100 includes the battery pack 50, a mounting portion is formed on or connected to the housing 10, and the battery pack 50 is detachably disposed on the mounting portion. In some examples, the surface treatment tool 100 includes a power cord, a connecting portion is formed on the housing 10, and the power cord is connected to the connecting portion.

The housing 10 extends basically along the front and rear direction, the working accessory 40 is disposed in front of the housing 10, and the energy source is disposed at the rear end of the housing 10. A grip 101 is formed on the housing 10 to facilitate the operation of the surface treatment tool 100. The grip 101 is located on the rear part of the housing 10. The extension direction of the grip 101 is the front and rear direction, and the left and right sides of the extension direction of the grip 101 are the left and right direction.

The surface treatment tool 100 further includes a trigger 22 disposed at the front end of the grip 101 and located on the lower side of the housing 10. The trigger 22 is used for controlling the start and stop of the electric motor 21. The trigger 22 is positioned in a way that facilitates the start and stop operations when the surface treatment tool 100 is held.

An auxiliary handle 60 is disposed on the housing 10. The auxiliary handle 60 has an accommodation cavity 601. The accommodation cavity 601 is used for accommodating a wrench 80. By providing the accommodation cavity 601 in the auxiliary handle 60, the space can be fully utilized to accommodate the wrench 80 or other accessories. In some examples, the auxiliary handle 60 is U-shaped. The auxiliary handle 60 is disposed on the front side of the housing 10 and extends upward. In the front and rear direction, the auxiliary handle 60 is tilted, conforms to the ergonomic design, is non-slip, provides a comfortable and good grip, and enables effortless operation during long-term work, thereby enhancing user experience.

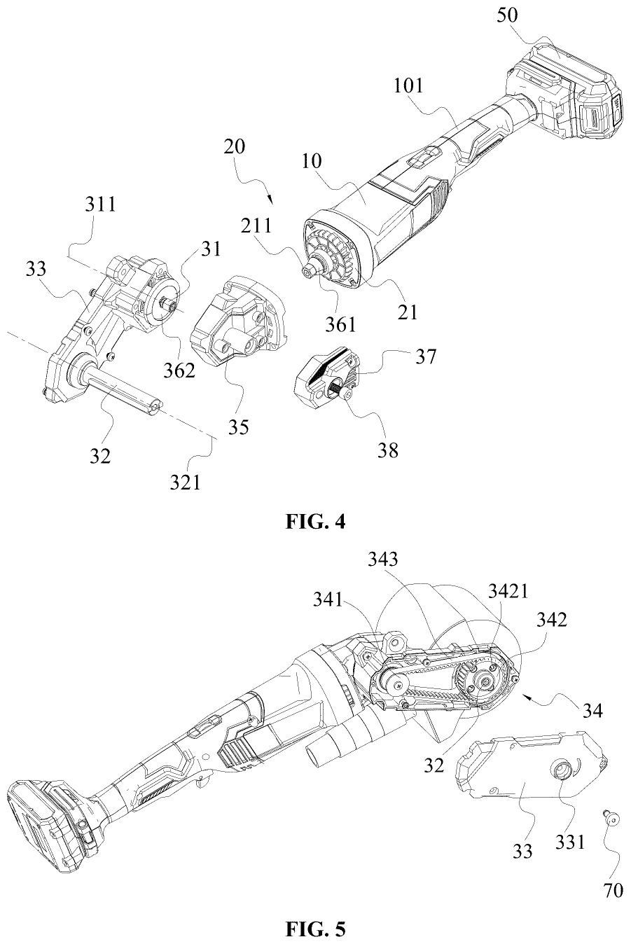

In some examples, the output shaft 32 and the input shaft 31 may be connected by a gear transmission mechanism. In this example, as shown in FIGS. 4 and 5, the transmission system 30 further includes a first housing 33 and a belt transmission mechanism 34 disposed in the first housing 33, the belt transmission mechanism 34 is drivingly connected to the input shaft 31 and the output shaft 32, and the input shaft 31 and the output shaft 32 both penetrate the first housing 33. By adopting the belt transmission mechanism 34, the stability of the working accessory 40 during the operation process can be effectively ensured, the frequency of the vibration of the working accessory 40 and the entire surface treatment tool 100 can be reduced, and the generated noise can be reduced, thereby enhancing user experience.

The belt transmission mechanism 34 includes a driving pulley 341, a driven pulley 342, and a belt 343 wound around the driving pulley 341 and the driven pulley 342, the driving pulley 341 is disposed on the input shaft 31, and the driven pulley 342 is disposed on the output shaft 32.

A shaft locking structure 70 is disposed on the first housing 33 and can lock the driven pulley 342. Locking the driven pulley 342 means locking the output shaft 32, thereby preventing the belt 343 from being broken due to an excessive force when the working accessory 40 is mounted or removed.

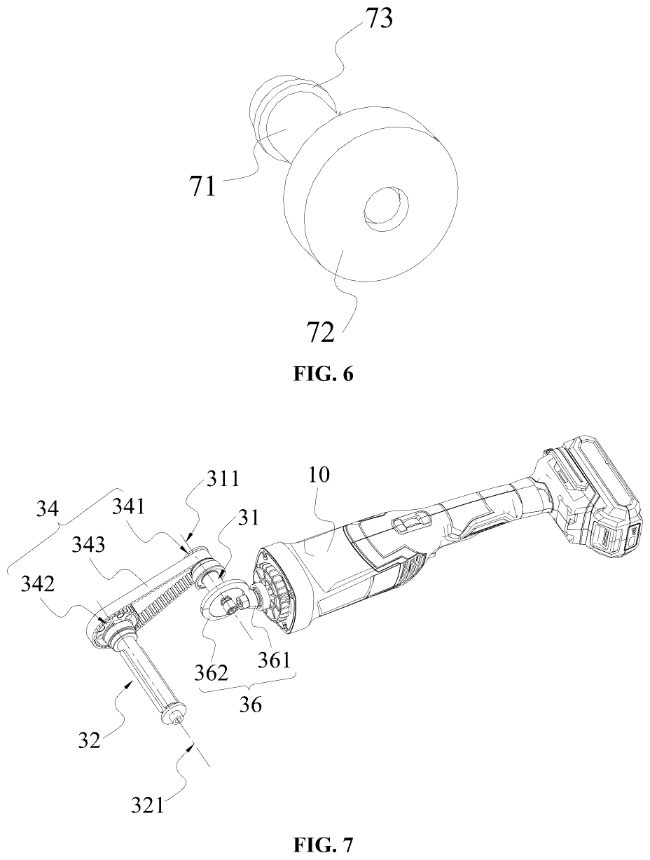

As shown in FIGS. 5 and 6, the shaft locking structure 70 includes a limiting rod 71 and a spring (not shown in the figure). The limiting rod 71 is elastically connected to the first housing 33 through the spring. The limiting rod 71 can move between a locked position and an unlocked position. Multiple limiting holes 3421 are arranged around the axis on the driven pulley 342. When the limiting rod 71 is at the locked position, the limiting rod 71 is inserted into the limiting hole 3421. When the limiting rod 71 is at the unlocked position, the limiting rod 71 is disengaged from the limiting hole 3421. When the operator presses an end of the limiting rod 71, the limiting rod 71 can be driven to move from the unlocked position to the locked position. When the operator releases the limiting rod 71, the spring is reset under the action of its own elasticity and can drive the limiting rod 71 to move from the locked position to the unlocked position.

Specifically, a button 72 is disposed at an end of the limiting rod 71 and is convenient for the operator to press. A limiting protrusion 73 is circumferentially disposed on the limiting rod 71. A stepped hole 331 is provided on the first housing 33. The limiting rod 71 penetrates the stepped hole 331. The limiting protrusion 73 limits the limiting rod 71 to prevent the limiting rod 71 from disengaging from the stepped hole 331. The spring is sleeved on the limiting rod 71, an end of the spring abuts against the button 72, and the other end of the spring abuts against the stepped surface of the stepped hole 331.

As shown in FIGS. 4 and 7, the transmission system 30 further includes a second housing 35 and a bevel gear transmission mechanism 36 disposed in the second housing 35, the input shaft 31 penetrates the second housing 35, and the bevel gear transmission mechanism 36 is drivingly connected to the motor shaft 211 and the input shaft 31.

The bevel gear transmission mechanism 36 includes a first bevel gear 361 and a second bevel gear 362. The first bevel gear 361 is disposed on the motor shaft 211, the second bevel gear 362 is disposed on the input shaft 31, and the first bevel gear 361 meshes with the second bevel gear 362.

The transmission system 30 further includes a connecting housing 37, the second housing 35 is located between the connecting housing 37 and the first housing 33, the second housing 35 and the housing 10 are detachably connected via a first locking member, and the first housing 33, the second housing 35, and the connecting housing 37 are detachably connected via a second locking member 38.

During installation, the motor shaft 211 and the first bevel gear 361 are inserted into the second housing 35, the second housing 35 and the housing 10 are connected via the first locking member, and then the input shaft 31 is inserted into the second housing 35 so that the first bevel gear 361 meshes with the second bevel gear 362. At this time, the first housing 33 abuts against a side of the second housing 35, the connecting housing 37 abuts against the other side of the second housing 35, and the first housing 33, the second housing 35, and the connecting housing 37 are connected via the second locking member 38. The first locking member and the second locking member 38 may be bolts.

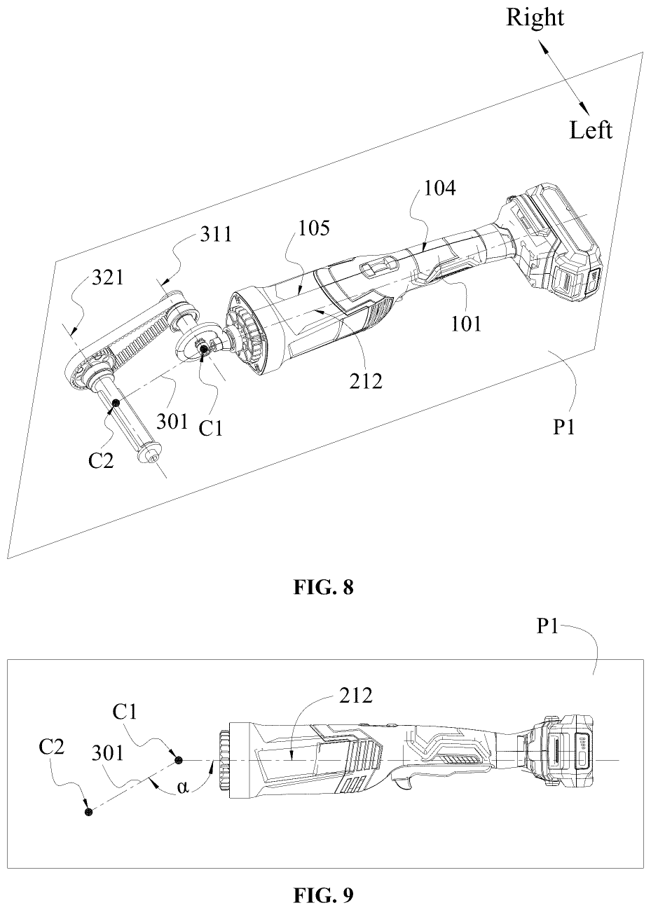

As shown in FIGS. 8 and 9, a first plane P1 is defined. The first plane P1 is basically perpendicular to the left and right direction of the surface treatment tool 100, the point of intersection between the first plane P1 and the input axis 311 is a first point of intersection C1, the point of intersection between the first plane P1 and the output axis 321 is a second point of intersection C2, the line connecting the first point of intersection C1 and the second point of intersection C2 is a transmission centerline 301, the included angle between the projection line of the motor axis 212 onto the first plane P1 and the transmission centerline 301 is a first included angle α, and the first included angle α is greater than or equal to 90 degrees and less than or equal to 170 degrees. The whole machine is no longer arranged in a straight line, and the space between the transmission centerline 301 and the motor axis 212 is convenient for arranging other components. When the motor axis 212 is located on the first plane P1, the first included angle α is the included angle between the transmission centerline 301 and the motor axis 212. When the motor axis 212 intersects or is basically parallel to the first plane P1, the first included angle α is the included angle between the projection line of the motor axis 212 onto the first plane P1 and the transmission centerline 301.

In some examples, the first included angle α is greater than or equal to 120 degrees and less than or equal to 160 degrees. In some examples, the first included angle α is equal to 130 degrees, 140 degrees, 150 degrees, or 155 degrees.

In some examples, the included angle formed by the motor axis 212 and the extension direction of the grip 101 is greater than 0 degrees and less than 90 degrees so that the grip 101 is convenient to hold. In some examples, the grip 101 extends basically along a first straight line 105, and the first straight line 105 is within the first plane P1.

When the housing is divided into two detachable parts, the two parts snap together, and an assembly line 104 is formed at the snapping position. In some examples, the assembly line 104 is located within the first plane P1. In some examples, the assembly line 104 is located outside the first plane P1, and the electric motor 21 is biased within the housing 10.

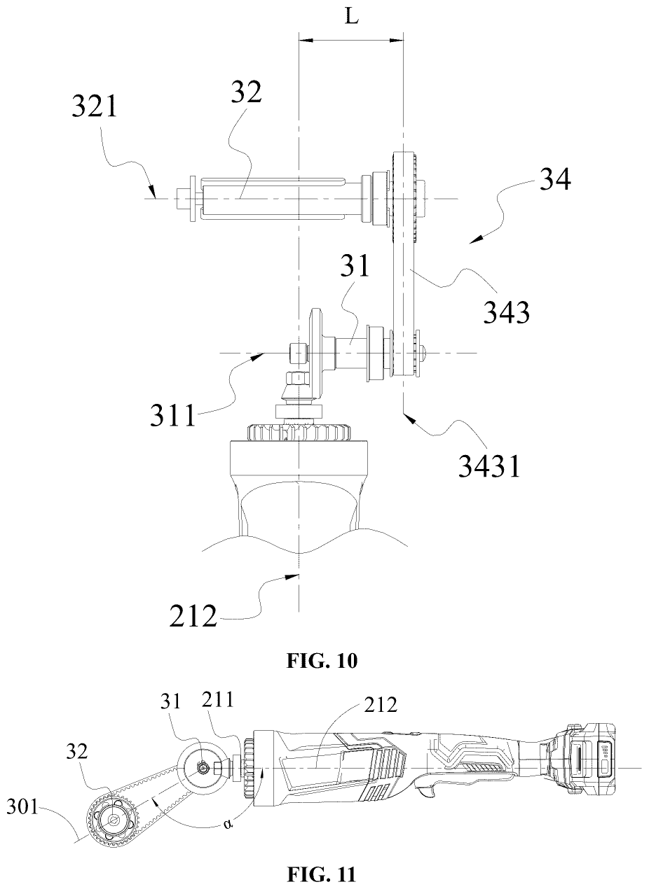

As shown in FIGS. 10 and 11, in an example, the input axis 311 is basically parallel to the output axis 321, thereby facilitating the arrangement of the transmission mechanism. The input axis 311 is basically perpendicular to the motor axis 212, and the output axis 321 is basically perpendicular to the motor axis 212.

When the belt transmission mechanism 34 is used, the belt 343 is wound around the driving pulley 341 and the driven pulley 342, and the belt 343 extends basically along a belt extension line 3431. Along the extension direction of the input shaft 31, the distance between the motor axis 212 and the belt extension line 3431 is a first distance L, and the first distance L is greater than or equal to 4 cm and less than or equal to 10 cm, thereby ensuring the balance of the whole machine. In some examples, the first distance L is greater than or equal to 5 cm and less than or equal to 8 cm.

The belt transmission mechanism 34 is located in front of the electric motor 21 and biased to the left or right side of the motor axis 212. In this example, the belt transmission mechanism 34 is biased to the right side of the motor axis 212. Generally, the operator holds the housing 10 with the right hand, and the belt transmission mechanism 34 is biased to the right side of the motor axis 212 so that the working accessory 40 on the output shaft 32 is adjacent to the operator and thus convenient for the operator to observe.

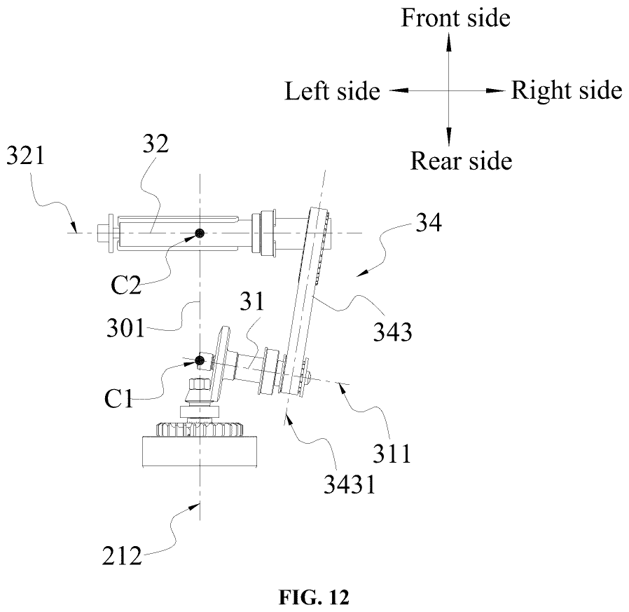

In some examples, at least one of the input axis 311 and the output axis 321 is basically perpendicular to the motor axis 212. In an example, the input axis 311 is basically perpendicular to the motor axis 212, and the input axis 311 and the output axis 321 are arranged at an included angle to each other. In another example, as shown in FIG. 12, the output axis 321 is basically perpendicular to the motor axis 212, and the input axis 311 and the output axis 321 are arranged at an included angle to each other.

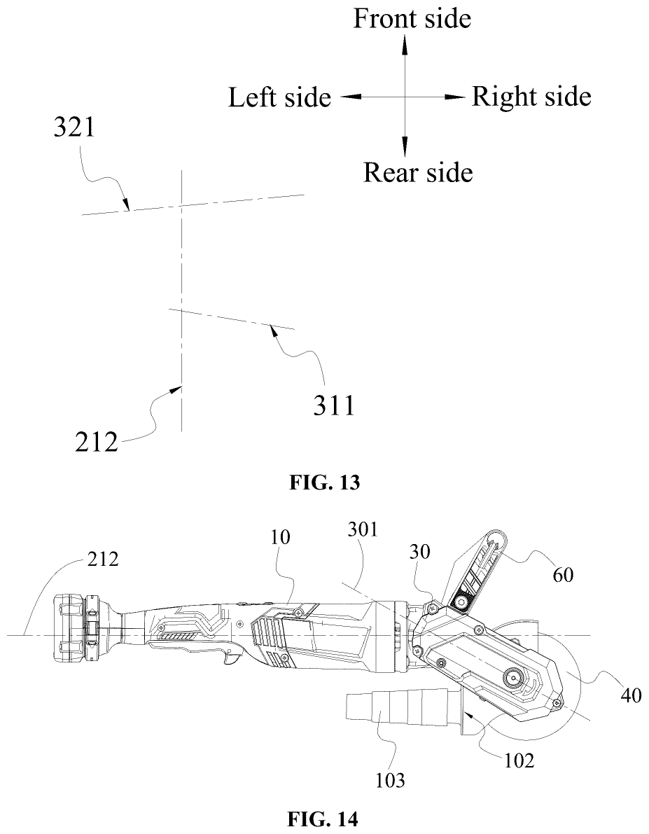

In some examples, as shown in FIG. 13, the input axis 311 and the output axis 321 are arranged at an included angle to each other, and neither of the input axis 311 and the output axis 321 is perpendicular to the motor axis 212.

As shown in FIGS. 8 and 14, a dust suction port 102 is disposed below the housing 10, the dust generated during the operation of the surface treatment tool 100 is discharged into a dust collection device through the dust suction port 102, and the dust suction port 102 is located between the motor axis 212 and the transmission centerline 301. The space between the motor axis 212 and the transmission centerline 301 is fully utilized to optimize the layout of the whole machine. In the related art, the dust suction port 102 is located at a relatively high position, and the dust needs to be lifted up before being sucked away, resulting in low dust suction efficiency. The dust suction port 102 in the present application is located at a relatively low position so that the dust is directly sucked away, and the dust suction efficiency is high.

Specifically, a guard 41 is disposed on the outer circumference of the working accessory 40, and the dust suction port 102 is disposed on the guard 41. The guard 41 is connected to the housing of the transmission system 30. In some examples, the dust suction port 102 is located below the electric motor 21. In some examples, the dust suction port 102 is located below the motor axis 212. In some examples, the dust suction port 102 is located below the auxiliary handle 60. In some examples, the dust suction port 102 is located below the belt 343.

A dust suction pipe 103 is disposed at the dust suction port 102, and a certain space is provided between the motor axis 212 and the transmission centerline 301 so that the dust suction pipe 103 can be prevented from hindering the movement of the tool. In the vertical direction, the dust suction pipe 103 at least partially overlaps the housing 10. In some examples, the dust suction pipe 103 extends parallel to the motor axis 212 so that the dust suction pipe 103 is completely located behind the working accessory 40 and can be prevented from hindering the movement of the tool.

The dust suction pipe 103 is detachable for easy maintenance and specifically, may be connected via threads. The dust suction port 102 may be connected to a vacuum cleaner.

The dust suction pipe 103 has a stepped structure, that is, the inner diameter of the dust suction pipe 103 becomes smaller and smaller from an end connected to the guard 41 along the direction away from the guard 41, thereby effectively improving the dust removal efficiency.

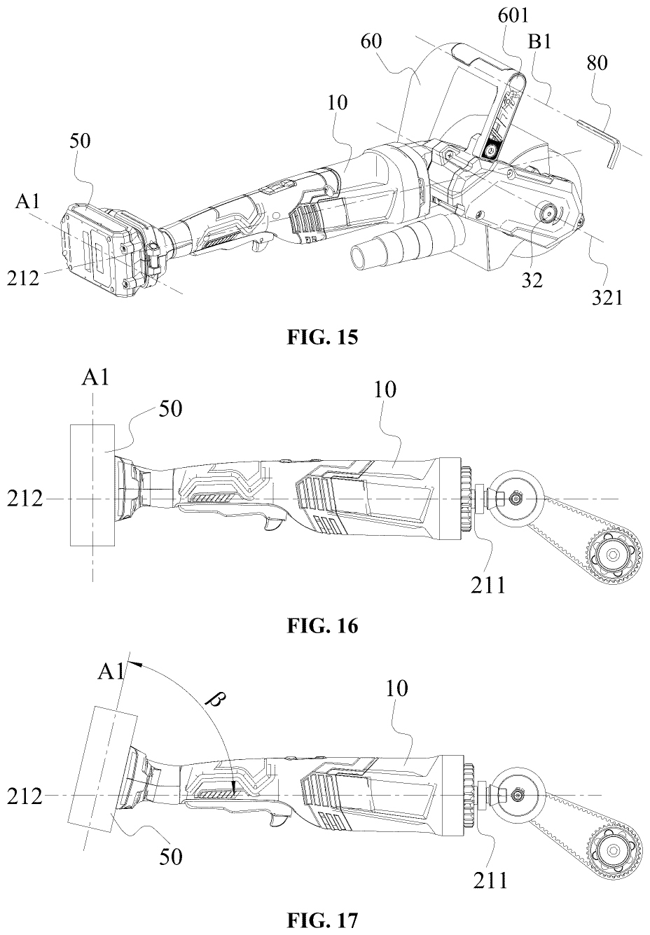

As shown in FIGS. 15 to 17, a second included angle β is formed between the plugging and unplugging direction A1 of the battery pack 50 and the motor axis 212, and the second included angle β is greater than or equal to 0 degrees and less than or equal to 90 degrees. In some examples, the second included angle β is equal to 90 degrees, the plugging and unplugging direction A1 of the battery pack 50 is perpendicular to the motor axis 212, and at this time, the plugging and unplugging direction A1 of the battery pack 50 is parallel to or perpendicular to the output axis 321. In some examples, the second included angle β is greater than or equal to 10 degrees and less than or equal to 80 degrees. In some examples, the second included angle β is greater than or equal to 30 degrees and less than or equal to 60 degrees.

The wrench 80 can be inserted into the accommodation cavity 601 along the direction of a second straight line B1, and the second straight line B1 is perpendicular to the motor axis 212. That is, the wrench 80 is inserted into the accommodation cavity 601 basically along the left and right direction, and the opening of the accommodation cavity 601 is located on the left or right side of the auxiliary handle 60 and does not affect the grip on the top of the auxiliary handle 60. The working accessory 40 can be disassembled by the wrench 80. Various working accessories 40 are provided and can be replaced as needed.

In some examples, the wrench 80 is magnetically connected to the auxiliary handle 60. In some examples, the wrench 80 is snap-fitted to the auxiliary handle 60.

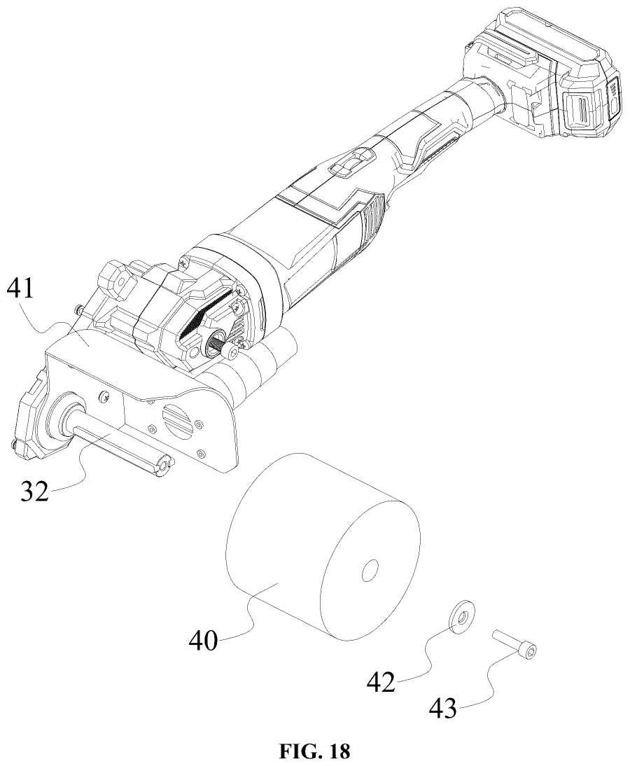

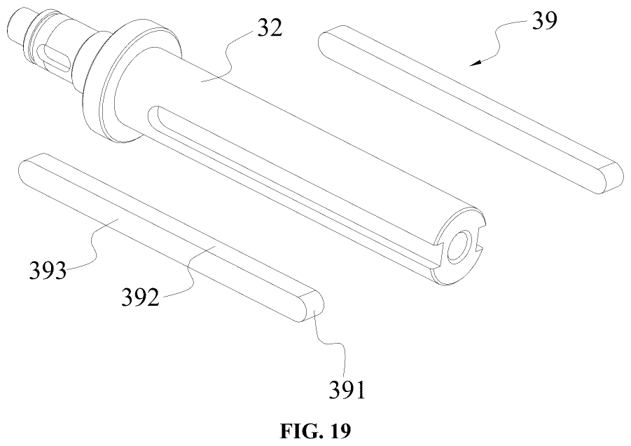

As shown in FIGS. 18 and 19, the working accessory 40 is connected to the output shaft 32 via two flat keys 39. Only when the flat keys 39 are correctly mounted in grooves 322 of the output shaft 32, an installation opening 44 of the working accessory 40 can be mounted on the output shaft 32. By providing two flat keys 39, the transmission effect between the working accessory 40 and the output shaft 32 is better, and the stability is better. A gasket 42 and a locking member 43 are disposed at the end of the output shaft 32 and used for limiting the position of the working accessory 40. The locking member 43 can be mounted and disassembled by the wrench 80.

The flat keys in the related art are mostly in the shape of a cuboid, and the cross section is generally a rectangle. However, the long side and the short side of the rectangle are not much different, so it is not easy to distinguish between the long side and the short side. As a result, during installation, the flat keys are often mounted in a wrong orientation. It is found that the working accessory 40 cannot mate with the output shaft 32 only when the working accessory 40 is sleeved, and the flat keys 39 need to be reinstalled, affecting the assembly efficiency.

As shown in FIG. 19, the flat key 39 provided in the present application has an arc portion 391 formed at least one end of the flat key 39 so that the flat key 39 has a first surface 392 and a second surface 393 in different shapes. The first surface 392 is basically rectangular, and the end of the second surface 393 has an arc, so it is easy to distinguish between the first surface 392 and the second surface 393 during assembly, thereby improving the assembly efficiency.

In some examples, the flat keys 39 are magnetic, and the flat keys 39 can be attracted to the output shaft 32, thereby preventing the flat keys 39 from falling off when the working accessory 40 is mounted.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A surface treatment tool, comprising:
a housing;
a drive assembly disposed in the housing and comprising an electric motor having a motor shaft that is rotatable about a motor axis;
a transmission system driven by the electric motor to rotate and comprising an input shaft that is connected to the motor shaft and rotatable about an input axis and an output shaft that is drivingly connected to the input shaft and rotatable about an output axis; and
a working accessory connected to the output shaft and rotatable about the output axis;
wherein a point of intersection between a first plane P1 that is basically perpendicular to a left and right direction of the surface treatment tool and the input axis is a first point of intersection C1, a point of intersection between the first plane P1 and the output axis is a second point of intersection C2, a line connecting the first point of intersection C1 and the second point of intersection C2 is a transmission centerline, an included angle between a projection line of the motor axis onto the first plane P1 and the transmission centerline is a first included angle α, and the first included angle α is greater than or equal to 90 degrees and less than or equal to 170 degrees.

2. The surface treatment tool of claim 1, wherein the first included angle α is greater than or equal to 120 degrees and less than or equal to 160 degrees.

3. The surface treatment tool of claim 1, wherein, along an extension direction of the input shaft, a distance between the motor axis and the transmission centerline is a first distance L, and the first distance L is greater than or equal to 4 cm and less than or equal to 10 cm.

4. The surface treatment tool of claim 1, wherein a dust suction port is disposed below the housing, dust generated during operation of the surface treatment tool is discharged into a dust collection device through the dust suction port, and the dust suction port is located between the motor axis and the transmission centerline.

5. The surface treatment tool of claim 4, wherein a dust suction pipe is disposed at the dust suction port, and, in a vertical direction, the dust suction pipe at least partially overlaps the housing.

6. The surface treatment tool of claim 4, wherein the dust suction port is located below the electric motor.

7. The surface treatment tool of claim 1, wherein the transmission system further comprises a first housing and a belt transmission mechanism disposed in the first housing, the belt transmission mechanism is drivingly connected to the input shaft and the output shaft, and the input shaft and the output shaft both penetrate the first housing.

8. The surface treatment tool of claim 7, wherein the belt transmission mechanism is located in front of the electric motor and biased to a left side or a right side of the motor axis.

9. The surface treatment tool of claim 7, wherein the belt transmission mechanism comprises a driving pulley, a driven pulley, and a belt wound around the driving pulley and the driven pulley, the driving pulley is disposed on the input shaft, and the driven pulley is disposed on the output shaft.

10. The surface treatment tool of claim 9, wherein a shaft locking structure is disposed on the first housing and is capable of locking the driven pulley.

11. The surface treatment tool of claim 7, wherein the transmission system further comprises a second housing and a bevel gear transmission mechanism disposed in the second housing, the input shaft penetrates the second housing, and the bevel gear transmission mechanism is drivingly connected to the motor shaft and the input shaft.

12. The surface treatment tool of claim 11, wherein the bevel gear transmission mechanism comprises a first bevel gear and a second bevel gear, the first bevel gear is disposed on the motor shaft, the second bevel gear is disposed on the input shaft, and the first bevel gear meshes with the second bevel gear.

13. The surface treatment tool of claim 11, wherein the transmission system further comprises a connecting housing, the second housing is located between the connecting housing and the first housing, the second housing and the housing are detachably connected via a first locking member, and the first housing, the second housing, and the connecting housing are detachably connected via a second locking member.

14. The surface treatment tool of claim 1, further comprising a battery pack and a mounting portion formed on or connected to the housing, wherein the battery pack is detachably disposed on the mounting portion, a second included angle β is formed between a plugging and unplugging direction of the battery pack and the motor axis, and the second included angle β is greater than or equal to 0 degrees and less than or equal to 90 degrees.

15. The surface treatment tool of claim 14, wherein the second included angle β is equal to 90 degrees, and the plugging and unplugging direction of the battery pack is parallel to or perpendicular to a central axis of the output shaft.

16. The surface treatment tool of claim 14, wherein the second included angle β is greater than or equal to 10 degrees and less than or equal to 80 degrees.

17. The surface treatment tool of claim 1, further comprising a power cord and a connecting portion formed on the housing, wherein the power cord is connected to the connecting portion.

18. The surface treatment tool of claim 1, wherein an auxiliary handle is disposed on the housing, the auxiliary handle has an accommodation cavity, and the accommodation cavity is configured to accommodate a wrench.

19. The surface treatment tool of claim 18, wherein the wrench is capable of being inserted into the accommodation cavity along a direction of a second straight line and the second straight line is perpendicular to the motor axis.

20. The surface treatment tool of claim 18, wherein the wrench is magnetically connected to the auxiliary handle.
